(19) United States
(12) Patent Application Publication
(10) Pub. No.: US 2025/0380643 A1
(43) Pub. Date: Dec. 18, 2025

(54) Progressive Bar Spacing in Concave Grates of Axial Flow Combine Harvesters to Promote Even Loading of Sieves

(71) Applicant: RAZOR'S EDGE US INC., Walhalla, ND (US)

(72) Inventor: Jeremy Matuszewski, Winkler (CA)

(21) Appl. No.: 19/287,973

(22) Filed: Aug. 1, 2025

Related U.S. Application Data
(63) Continuation of application No. PCT/US2025/026968, filed on Apr. 30, 2025.
(60) Provisional application No. 63/659,088, filed on Jun. 12, 2024.

(51) Int. Cl. A01F 12/26; A01D 41/12

(52) U.S. Cl. CPC A01F 12/26; A01D 41/12

(57) ABSTRACT

In an axial flow combine harvester, axial bars of one or more concave grates include first and second series of axial bars, of which the first series is nearer to a front intake end of the assembly where crop material is introduced. In each series, spacing between adjacent axial bars grows progressively wider from relatively narrow spacing near a first end of the series to relatively wider spacing near a second end of the series. The bar spacing in the second series is also of progressively widening character relative to the bar spacing in the first series. Operational characteristics of the combine harvester are improved by installation of the grates with the relatively narrow spacing at a side of the rotor where sieve overloading is known to occur with conventional grates, and with the wider spacing at an opposing side of the rotor from where said conventional sieve overloading occurs.

### CROSS-REFERENCE TO RELATED APPLICATIONS

This application is a bypass continuation of International PCT Application No. PCT/US2025/26968, filed Apr. 30, 2025, which claims priority benefit of U.S. Provisional Patent Application No. 63/659,088, filed Jun. 12, 2024, the entirety of which is incorporated herein by reference.

### FIELD OF THE INVENTION

The present invention relates generally to combine harvesters, and more particularly relates to performance optimization thereof through modification of concave grates that underlie and cooperate with an overlying rotor whose driven rotation is used to thresh and separate the crop material as it is advanced helically and axially around the driven rotor.

### BACKGROUND

In the agricultural industry, a combine harvester is a vehicle used for the harvesting of agricultural crops. Prior art combine harvesters are typically composed of several systems to pick, thresh, separate, clean and retain the grain from the particular crop being harvested. For example, in one type of prior art combine harvester's threshing system, often referred to as an “axial flow” setup, the crop travels axially parallel to and helically around the rotational axis of one or more rotary processing devices commonly referred to as rotors. In other prior art combine harvester's threshing systems, during at least a portion of its travel through the system, the crop travels in a transverse or tangential direction relative to the rotational axis of a rotary processing device commonly referred to as a threshing cylinder. In each of the prior art threshing systems, crop material is processed between rasp elements attached to the periphery of a rotary device and arcuate grates, usually foraminous, stationary, concave threshing and separating grates that at least partially wrap around the rotor in roughly circumferential and concentric relation thereto. The crop material travels around the rotary cylinder and is “wedged” in between the rotary cylinder and threshing concaves causing the grain to be removed from the stalk.

For example, Regier (U.S. Pat. No. 9,215,845) discloses an exemplary prior art axial flow combine harvester. As shown in FIG. 1, the depicted combine harvester 10 has a single axial flow rotary processing system 12 that extends generally parallel with the path of travel of the combine harvester 10, also referred to herein as a longitudinal direction thereof in which the combine harvester's front and rear ends are set apart from one another. This longitudinal direction sets a directional reference frame in which the terms front and rear are also used herein to label various parts or features of the combine harvester 10 and the present invention.

The exemplary prior art combine harvester 10 depicted in the drawings typically includes a harvesting header (not shown) at the front of the machine that picks or cuts the harvested crop and delivers the collected crop material to the front end of a feeder house 14. A conveyor 16 moves the crop material rearwardly within the feeder house 14 until reaching the processing system 12. With reference now to FIG. 2, the illustrated processing system 12 features a rotor 20 that has an infeed auger 22 on the front end thereof, and is rotatably driven about a rotor axis lying longitudinally of the combine harvester 10. The auger 22 and rotor 20 advance the crop material axially/longitudinally through the processing system 12 for threshing and separating. The rotor 20 typically includes a plurality of rasp-like elements 55, configured about the rotor's peripheral surface. The rotor is partially encased at its underside by a series of concave threshing grates 24 underlying a front lengthwise segment of the rotor and a rearwardly neighbouring series of concave separator grates 26 underlying a rear lengthwise segment of the rotor. As the crop material moves around and in-between the rasp-like elements 55 and the concave threshing grates 24, the crop is threshed. Any free grain, that has been threshed, falls through openings in the concave threshing grates 24 and the concave separator grates 26 and is retained by the combine harvester 10.

Generally speaking, the crop material entering the processing system 12 moves axially and helically through the system during threshing and separating. During such travel the crop material is threshed and separated by rotor 20 operating in cooperation with a concave foraminous separator 23 composed one or more such concave threshing grates 24 and one or more such concave separator grates 26, with the grain escaping through openings of the concave threshing grates 24 and concave separator grates 26 into an underlying cleaning mechanism 28 (FIG. 1). Bulkier stalk and leaf material is retained by the concave threshing grates 24 and separator grates 26, and is ejected out of the processing system 12 at the rear of the combine harvester 10. The cleaning mechanism 28 includes a set of oscillating sieves with small openings therein through the grain can fall, while the separated chaff cannot, and typically also includes a blower (not shown), which provides a stream of air directed upwardly through the sieves from therebelow and out the rear of the harvester 10 so as to exhaust the lighter chaff out the rear of the harvester while the heavier grain migrates downwardly toward the bottom of the harvester to a clean grain auger 30. This auger 30 delivers the clean grain to an elevator (not shown) that transfers the grain to a storage bin 34 on top of the machine, from which it is ultimately unloaded via an unloading spout 36.

The plurality of concave threshing grates 24 and concave separator grates 26 are arranged in side-by-side relation to one another in the longitudinal/axial direction the processing system 12 to form the foraminous separator 23, which in turn forms part of what may be considered a tubular housing 38 that concentrically receives rotor 20 and serves as part of processing system 12. In the illustrated example of FIGS. 1 and 2, there are three concave threshing grates 24 and three concave separator grates 26 that collectively form the foraminous separator 23 and bottom part of the tubular housing 38. However, it is understood that more or fewer concave threshing grates 24 and concave separator grates 26 may alternatively be used. The concavity of the threshing and separator grates 24, 26 refers to the shape at interior sides thereof that face toward the rotor, as opposed to the convexly shaped exterior sides thereof that face away from the rotor. As is known in the art, the tubular housing 38 may also include an internally concave and externally convex top part (not shown) that extends longitudinally of the housing 38 in overlying relation to the rotationally driven rotor. The concave threshing grates 24 are adjustably movable toward and away from rotor 20 to adjust the running clearance between the rotor 20 and the concave threshing grates, and to thereby change the shape of the threshing and separating regions, as is known in the art and need not be further discussed herein.

As shown in FIG. 3A, a concave threshing grate 40 typically includes a matching pair of arcuate, elongated and spaced-apart side rails 42A, 42B oriented generally transverse to the longitudinal axis of the rotor 20 so that the arcuate spans of these rails span angularly around a fraction of the rotor's circumference in a position therebeneath. The side rails 42A, 42B are spaced apart from one another in the axial/longitudinal direction, whereby the side rails can be more particularly identified as front side rail 42A and rear side rail 42B owing to their relative proximities to the front and rear ends of the combine harvester 10. A parallel series of axial bars 44 spaced at predetermined intervals from one another along the arcuate span of the side rails 42A, 42B span axially/longitudinally between the two side rails 42A, 42B. End plates 46A, 46B are typically affixed between the side rails 42A, 42B at terminal ends of their arcuate spans, As shown, one of these ends plates 46B may embody or be accompanied by a hooked end-bracket 48 at the respective terminal end of the grate's arcuate for installed support of the concave threshing grate 40 in the combine harvester 10 in a known manner, though such mounting details may vary from one combine harvester to another. End portions of the axial bars 44 are received in cooperatively shaped notches 50 in upper edges of the side rails 42A, 42B and affixed thereto for support thereby. One or more arcuate mid-rails 52 of matching or similar shape and configuration to the front and rear side rails 42A, 42B is/are typically positioned between and parallel to the front and rear side rails 42A, 42B at axially spaced distances therefrom to further support the axial bars 44. While the plurality of axial bars 44 shown FIGS. 3A to 4C are depicted as notched round bars each having a generally round cross-section with a flattened notch at one of its two upper quadrants, will be appreciated by those skilled in the art that the axial bars may have any variety of cross-sectional shape, such as fully-round, flat-topped round, oval, rectangular, square or polygonal.

To further set the context of the present invention, FIG. 3B illustrates an exemplary concave threshing grate assembly composed of a front concave threshing section 40A and a neighbouring second concave threshing section 40B situated rearwardly adjacent thereto, of which each concave threshing section 40A, 40B in this example is composed of a singular concave threshing grate of the same type illustrated in FIG. 3A. In other machines, each concave threshing section may be composed of a cooperating pair of concave threshing grates residing end-to-end with one another, and will be better understood later on with reference to one illustrated embodiment of the present invention. The two concave threshing sections 40A, 40B reside in side-by-side relation to one another with the rear side rail 42B of the front concave threshing section 40A in closely adjacent face-to-face relation to the front side rail 42A of the second concave threshing section 40B, thus resembling the installed relationship in which such two concave threshing section 40A, 40B would reside relative to one another when installed in the processing system 12 of the combine harvester 10. As shown, the front side rail 42A of the front concave threshing section 40A may have a front lip 54 attached thereto in a position jutting forwardly therefrom in radially outward flaring relation to the notched top edge of this front side rail 42A. This optionally lip-equipped front side rail 42A of the front concave threshing section 40A denotes a forwardmost intake end of the concave threshing grate assembly and the overall concave foraminous separator 23, thus coinciding with an entrance end of the tubular housing 38 through which the crop material is first admitted to the processing system 12. The second concave threshing section 40B denotes the second frontmost concave threshing section, of which only the front concave threshing section 40A is of more immediately adjacent relation to this entrance of the processing system. The concave foraminous separator 23 will typically also include at least one concave separator section 26 installed rearwardly of the two illustrated concave threshing section 40A, 40B of the concave threshing grate assembly, and optionally may include one or more additional concave threshing section installed rearwardly of the first two concave threshing section 40A, 40B and in front of the one or more concave separator sections. That said, only the first two concave threshing sections 40A, 40B of the concave foraminous separator 23 are illustrated herein.

Having set the context of the present invention through the foregoing description, it has become understood by the Applicant that less than optimal performance and efficiency of the forgoing type of combine harvester can be at least partially attributed to uneven loading of the sieves of the cleaning mechanism 28 from the processing system 12, where the revolving action between the rotor and the concave threshing and separating grates in a single-rotor combine harvester causes the threshed grain to be distributed more to one side of the sieves than the other. In some single-rotor machines, this overloading of the sieves seems to occur on the side of the machine corresponding to the downwardly rotating side of the rotor, yet in other single-rotor machines, the overloaded side is that corresponding to the upwardly rotating side of the rotor, leading to the conclusion that the direction of rotor spin, in at least some single-rotor machines, does not alone dictate why, how and where overloading of the sieves may occur. On the other hand, in at least some twin-rotor combine harvesters, the threshed grain has been found to be distributed too heavily toward the center of the machine in designs where the two rotors rotate in directions spinning toward the center of the machine in the bottom halves of their rotation, and too heavily away from the center of the machine in designs where the two rotors rotate in the opposing direction spinning away from the center of the machine at the bottom halves of their rotation.

In any of these various combine harvesters, the result of this uneven loading of the sieves is that the effectiveness of the intended cleaning action imparted by the sieves can be negatively impacted, and the overall cleaning capacity of the combine harvester is underutilized, denoting less than optimal operating efficiency of the machine.

U.S. Pat. No. 8,454,416 by Estes, the entirety of which is incorporated herein by reference, discloses a concave threshing grate in which spacing between the axial bars in the progressively increases in width, from about 1.75 to 2.34 inches center-to-center, in matching direction to the rotor spin, with the purposeful intent of unloading the crop material sooner to avoid overloading of the separating section further downstream. No attention is given to uneven loading of the sieves across the width of the machine, nor to the cause thereof, and the progressive widening of the bar spacing specifically in the rotor spin direction could conceivably contribute to a worsening of the uneven sieve-loading problem, depending on the type of machine.

Accordingly, there is a need for a solution to address the foregoing performance related deficiencies in both single and twin-rotor axial flow combine harvesters, which need is addressed by the present invention disclosed herein.

### SUMMARY OF THE INVENTION

According to a first aspect of the invention, there is provided a concave assembly for an axial flow combine harvester having at least one rotor, whose rotation axis lies longitudinally of the combine harvester and defines an axial direction, relative to which the concave assembly is designed for installation thereof in a position and orientation underlying said rotor and arching transversely of the rotation axis in radially spaced relation from the rotor to span partially therearound in a circumferential direction, wherein the concave assembly comprises:
one or more concave sections comprising one or more concave grates having arc-shaped rails spanning in said circumferential direction and axial bars supported on said arc-shaped rails and lying parallel to one another in the axial direction;
said axial bars comprising at least:
   a first series of axial bars distributed in spaced apart relation to one another in the circumferential direction spanned by the arc-shaped rails; and
   a second series of axial bars also distributed in spaced apart relation to one another in the circumferential direction spanned by the arc-shaped rails;
among which the first and second series occupy longitudinally distinct first and regions of the concave assembly, of which the first region resides nearer to a front intake end of the concave assembly, at which crop material is first introduced to the concave assembly during use of the combine harvester, than to a longitudinally opposing terminal rear end of the concave assembly, toward which the crop material is axially advanced by helical movement around the rotor in use of the combine harvester;
wherein spacing between adjacent pairs of the axial bars in each series, of which a respective two bars of each pair reside on a same one of the grates within a same one of the series, within each series is characterized, at least for the most part, by a progressively widening character that grows progressively wider from a relatively narrow spacing at or near a first end of the series to a relatively wider spacing at or near an opposing second end of the series, and the spacing between said adjacent pairs of the axial bars, in the second series, is further characterized, at least for the most part, by a progressive widening thereof relative to the spacing between the adjacent pairs of the axial bars in the first series.

According to a second aspect of the invention, there is provided an axial flow combine harvester having installed therein the concave assembly according to the first aspect of the invention.

In some combine harvesters, the rotor spin direction of the rotor, at a bottom half of each rotation thereof, is of matching directional relationship to the progressively widening character of the spacing between the adjacent bars.

In other combine harvesters, the rotor spin direction of the rotor, at a bottom half of each rotation thereof, is of opposite directional relationship to the progressively widening character of the spacing between the adjacent bars.

In some twin-rotor combine harvesters, the two concave assemblies are installed in orientations in which the progressively widening character of the spacing the adjacent bars grows progressively wider toward a vertical midplane that lies axially of, and in-between, the two rotors.

Typically, the two rotors of these twin-rotor combine harvesters are driven in counter-rotating directions that, in a bottom half each rotor's driven rotation, spins the rotor outwardly away from the midplane.

In other twin-rotor combine harvesters the two concave assemblies are installed in orientations in which the progressively widening character of the spacing the adjacent bars grows progressively wider outwardly away from the vertical midplane.

Typically, the two rotors of these twin-rotor combine harvesters are driven in counter-rotating directions that, in a bottom half each rotor's driven rotation, spins the rotor inwardly toward the midplane.

According to a third aspect of the invention, there is provided a method of improving operational characteristics of an axial flow combine harvester in which unloading of one or more concave grates of a conventional design for said combine harvester to cooperating sieves of the combine harvester is known to involve uneven loading of said sieves from said one or more concave grates, said method comprising obtaining one or more concave grates possessing at least one series of axial bars that, for at least the most part, are laid out with progressively wider spaces between adjacent pairs of said bars starting from a relatively narrow spacing at or near a first end of the series to a relatively wider spacing at or near an opposing second end of the series, and installing said one or more concave grates in operational relationship to a rotor of said axial flow combine harvester in an installed position where the relatively narrow spacing resides at a side of the rotor where sieve overloading is known to occur with said one or more concave grates of a conventional design, and said relatively wider spacing resides at an opposing side of the rotor from said sieve overloading is known to occur.

### BRIEF DESCRIPTION OF THE DRAWINGS

Preferred embodiments of the invention will now be described in conjunction with the accompanying drawings in which:

FIG. 1 is a schematic side elevational view of a prior art combine harvester having a single-rotor axial-flow processing system, with portion of the harvester cut away to reveal internal details thereof.

FIG. 2 is a perspective view of a known type of rotor and cooperating set of concave threshing and separating grates belonging to the processing system of the FIG. 1 combine harvester.

FIG. 3A is a perspective view of a singular isolated concave threshing grate of a known type usable in a processing system of matching or comparable type to that of FIGS. 1 and 2.

FIG. 3B is a perspective view of a neighbouring pair of concave threshing grates of the known type shown in FIG. 3A, as they would reside side-by-side in a combine harvester processing system of a matching or comparable type to that of FIGS. 1 and 2.

FIG. 4A is a perspective view of a threshing grate assembly formed by a set of concave threshing grates according a first embodiment of the present invention, among which the grates are arranged in two end-to-end pairs, each forming a respective arcuate section of the assembly, for use in a first type of single-rotor axial-flow combine harvester.

FIG. 4B is an exploded perspective view of the threshing grate assembly of FIG. 4A, in which the two pairs of grates have been exploded apart.

FIG. 4C is a cross-sectional view of the first pair of threshing gates from the threshing grate set of FIG. 4A as viewed along line C-C thereof, shown in their working context relative to a schematically illustrator rotor of the first type of single-rotor axial-flow combine harvester, and illustrating progressively increasing bar spacing within each grate in a direction matching the direction of rotor spin to achieve a more balanced unloading of the grates across the width of the machine.

FIG. 4D is a cross-sectional view of the second pair of threshing gates from the threshing grate set of FIG. 4A as viewed along line D-D thereof, shown in the same working context as FIG. 4C, and again illustrating progressively increasing bar spacing within each grate in a direction matching the direction of rotor spin.

FIG. 5A is a perspective view of a threshing grate assembly formed by a set of concave threshing grates according a second embodiment of the present invention, among which each arcuate section of the assembly consists of a singular grate for use in a second type of single-rotor axial-flow combine harvester.

FIG. 5B is an exploded perspective view of the threshing grate assembly of FIG. 5A, in which individual grates have been exploded apart.

FIG. 5C is a cross-sectional view of a first grate of FIG. 5B as seen along line C-C thereof, shown in its working context relative to a schematically illustrator rotor of the second type of single-rotor axial-flow combine harvester, and illustrating progressively increasing bar spacing within the grate in a direction opposing the direction of rotor spin.

FIG. 5D is a cross-sectional view of the same first grate as FIG. 5C in the same working context thereof, but as cross-sectioned along line D-D of FIG. 5B.

FIG. 5E is a cross-sectional view of the second grate of FIG. 5B as viewed along line E-E thereof, shown in the same working context as FIG. 5C.

FIG. 5F is a cross-sectional view of the same second grate as FIG. 5E, but as cross-sectioned along line F-F of FIG. 5B.

FIG. 5G is a cross-sectional view of the third grate of FIG. 5B as viewed along line G-G thereof, shown in the same working context as FIG. 5C, and illustrating an even bar spacing of this grate at an area of the second type of single-rotor axial-flow machine where unloading of the concave grates and loading of the sieves is normally fairly even across the width of the machine, and requires no correction by variable bar spacing.

FIG. 6A schematically illustrates installation of concave threshing grates with progressively increasing bar spacing like those of the preceding embodiments, but in a twin-rotor combine harvester whose rotors, in this embodiment, are driven in a direction where they spin away from a center of the combine harvester in the bottom half of their rotation.

FIG. 6B schematically illustrates installation of concave threshing grates with progressively increasing bar spacing like those of the preceding embodiments, but in a twin-rotor combine harvester whose rotors, in this embodiment, are driven in a direction where they spin toward the center of the combine harvester in the bottom half of their rotation.

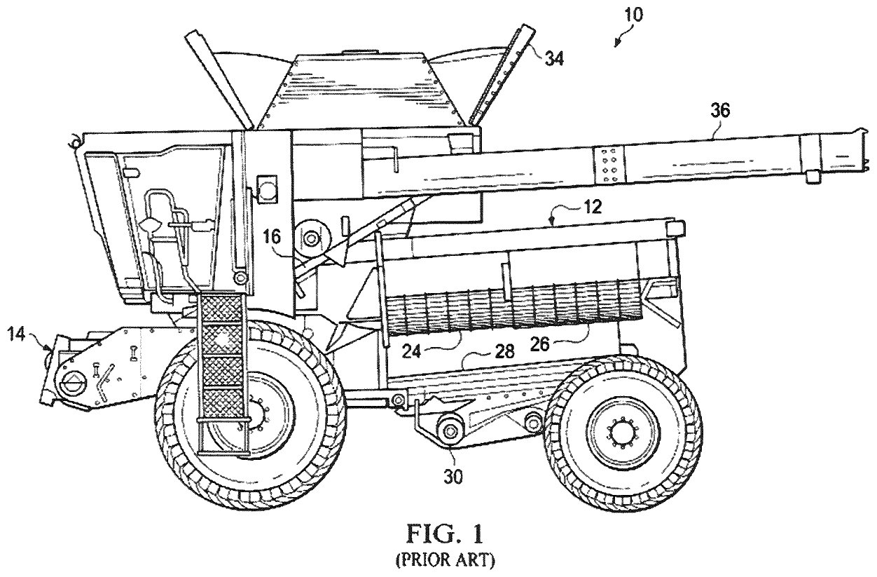

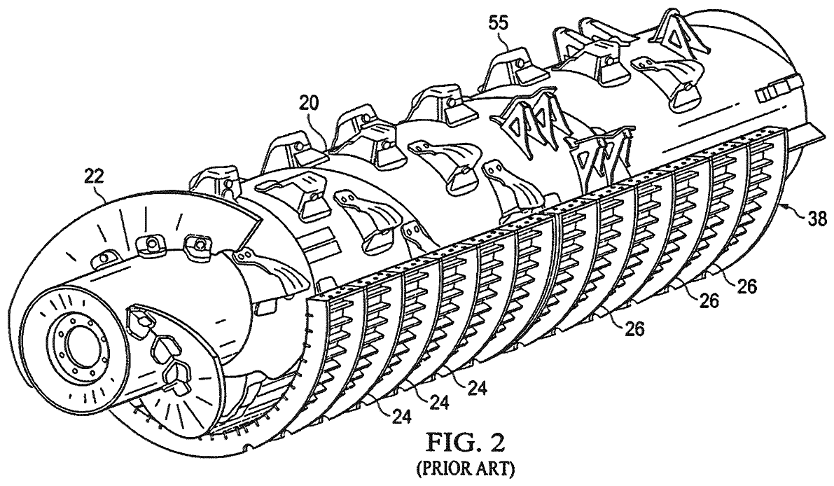

### DETAILED DESCRIPTION

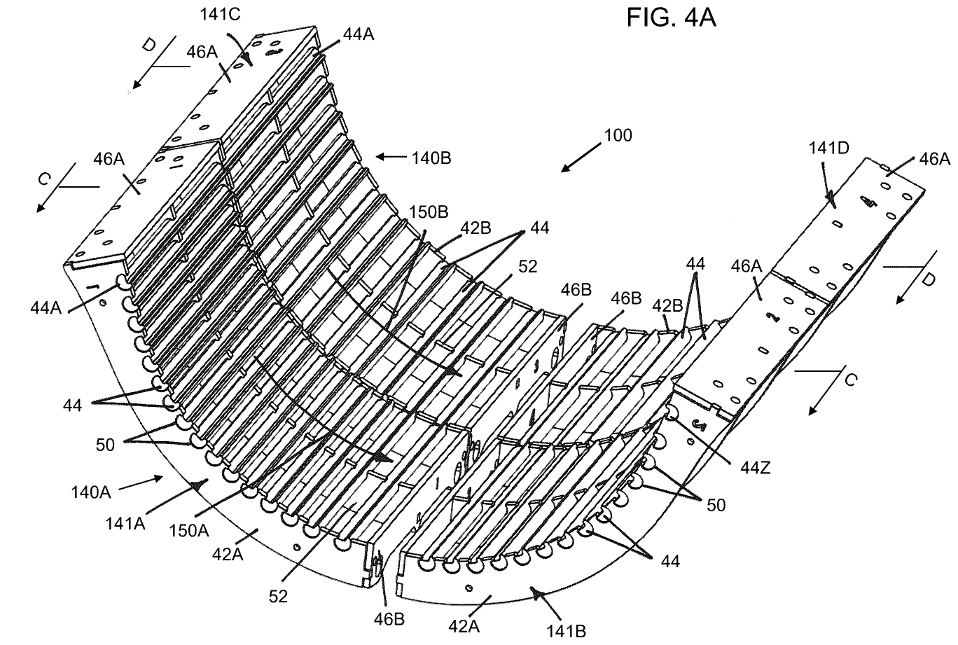

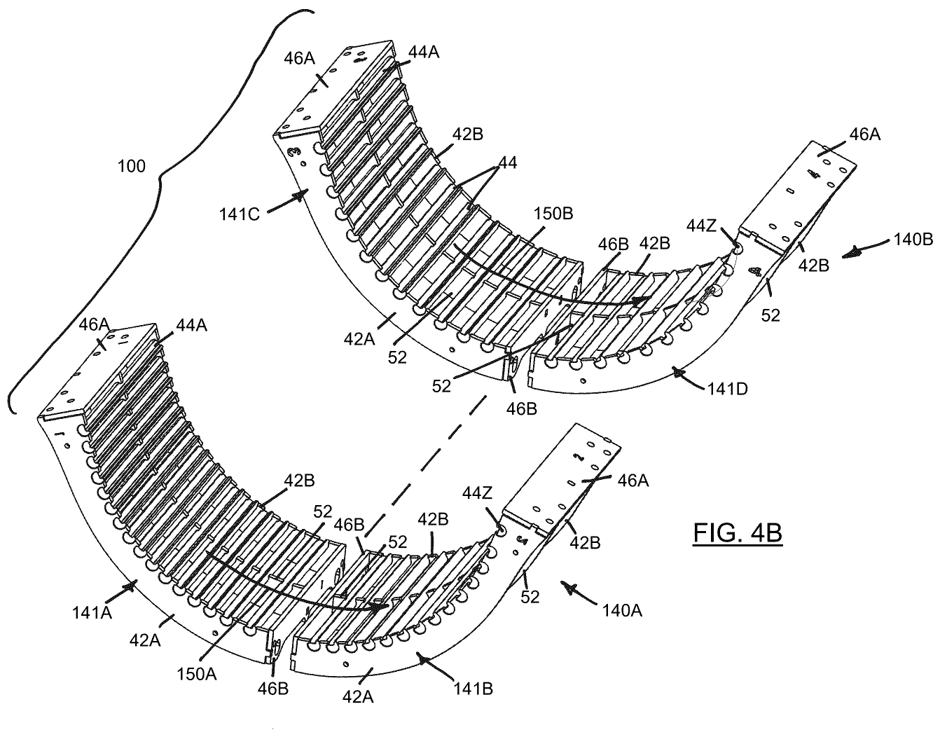

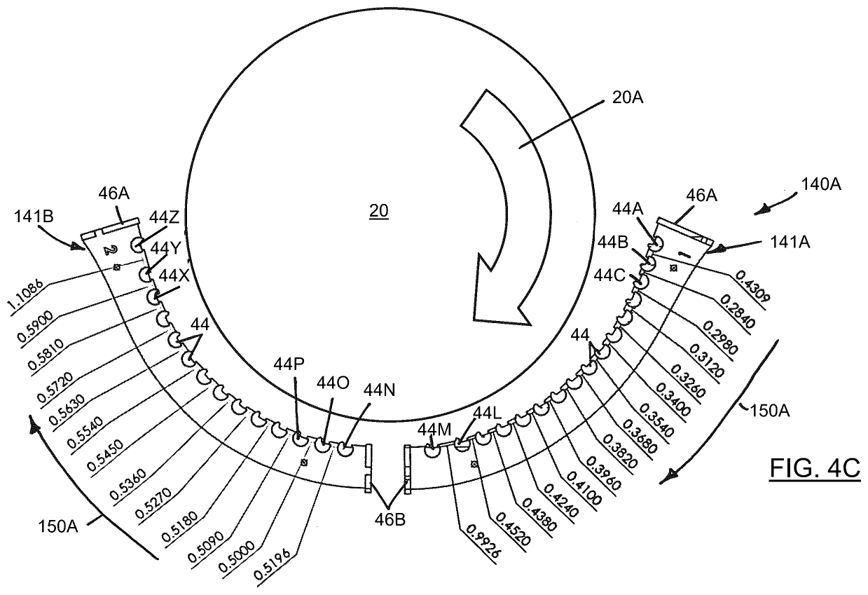

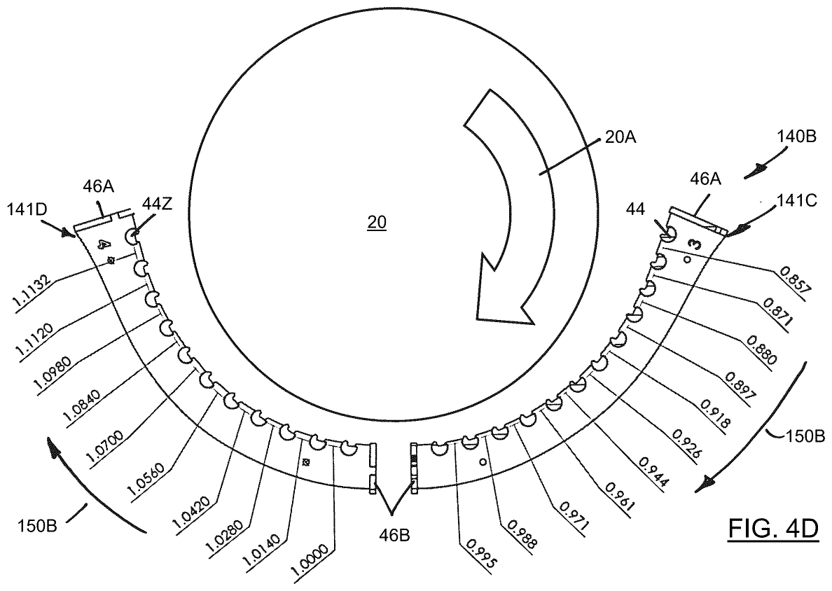

FIGS. 4A through 4D illustrate a concave threshing grate assembly 100 of the first embodiment of the invention, which features two concave threshing sections 140A, 140B each composed of a respective pair of cooperating concave threshing grates. A first and frontmost concave threshing section 140A is that which denotes the forwardmost intake end of the overall concave threshing grate assembly 100, and is composed of a first concave threshing grate 141A and a second concave threshing grate 141B that reside adjacently end-to-end to one another to span respective shares of an overall arcuate span of this frontmost concave threshing section 140A. A neighbouring second concave threshing section 140B is situated rearwardly adjacent of the first frontmost concave threshing sections, and is thus the second frontmost concave threshing section of the overall concave threshing grate assembly 100, and is composed of a third concave threshing grate 141C and a fourth concave threshing grate 141D that likewise reside adjacently end-to-end to one another to span respective shares of an overall arcuate span of this second concave threshing section 140B. The first concave threshing grate 141A of the first concave threshing section 140A and the third concave threshing grate 141C of the second concave threshing section 140B align with one another. Likewise, the second concave threshing grate 141B of the first concave threshing section 140A and the fourth concave threshing grate 141D of the second concave threshing section 140B align with one another.

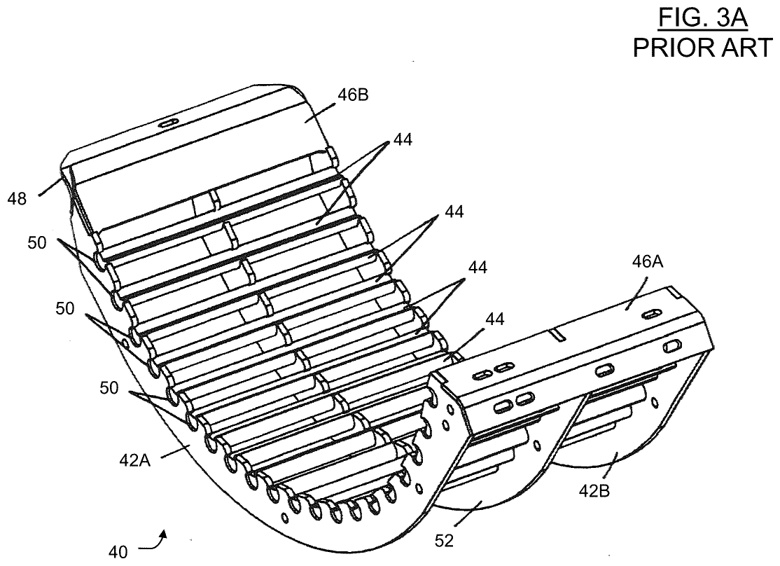

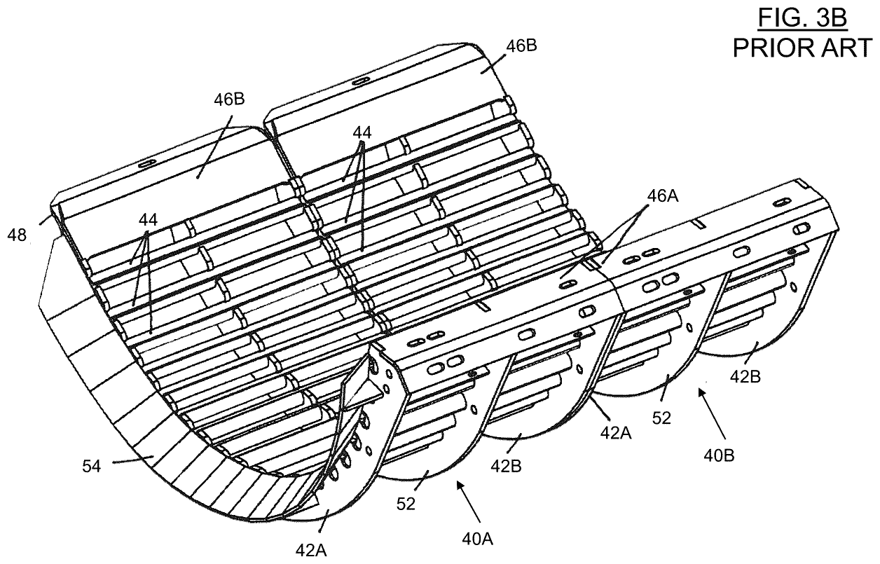

Each concave threshing grate 141A-141D has the same general structure described of the concave threshing grate 40 of FIG. 3A, thus possessing a matching pair of arcuate, elongated and spaced-apart front and rear side rails 42A, 42B to be oriented generally transverse to the longitudinal axis of the rotor 20 of a combine harvester so that the arcuate spans of these rails span angularly around a fraction of the rotor's circumference in a position spaced radially therebeneath, a parallel series of axial bars 44 spaced at predetermined intervals from one another along the arcuate span of the side rails 42A, 42B to span axially/longitudinally between the two side rails 42A, 42B, and end plates 46A, 46B affixed between the side rails 42A, 42B at terminal ends of their arcuate spans. End portions of the axial bars 44 are again received in cooperatively shaped notches 50 in upper edges of the side rails 42A, 42B and affixed thereto for support thereby. One or more arcuate mid-rails 52 of matching or similar shape and configuration to the front and rear side rails 42A, 42B is/are typically positioned between and parallel to the front and rear side rails 42A, 42B at axially spaced distances therefrom to further support the axial bars 44. As mentioned of FIG. 3A, the cross-sectional shapes of the axial bars 44 may vary, but are preferably of the notched type already described, and reflected in the illustrated example.

In this embodiment, end plate 46A of each concave threshing grate 141A-141D is an upper outside end plate thereof situated distally furthest from the other concave threshing grate of the same concave threshing section 140A, 140B. End plate 46B of each concave threshing grate 141A-141D is a lower inside end plate thereof situated proximally nearest the other concave threshing grate of the same concave threshing section 140A, 140B. The two lower inside end plates 46B of the two concave threshing grates of each concave threshing section 140A, 140B thus face together beneath the rotor 20 of the combine harvester in the installed state of the concave threshing assembly 100, as can be seen in the schematic illustrations thereof in FIGS. 4C and 4D. It can also be seen that the upper outside end plate 46A of each of the two concave threshing grates of each concave threshing section 140A, 140B face upwardly on opposite sides of the rotor 20 at opposing ends of the overall arcuate span of the concave threshing section 140A, 140B, as collectively denoted by the combined arcuate spans of the two concave threshing grates of the concave threshing section 140A, 140B.

The axial bars 44 of each concave threshing grate 141A-141D in this embodiment are full-length axial bars 44 spanning all the way between the front and rear side rails 42A, 42B of the grate, whereby each concave threshing section 140A, 140B has a singular series of full-length axial bars. The series of axial bars 44 begins with a starting bar 44A that resides closest to the upper outside end 46A of either the first concave threshing grate 141A of the first concave threshing section 140A or the third concave threshing grate 141C of the second concave threshing section 140B, and terminates with a terminal bar 44Z closest to the upper outside end 46A of either the second concave threshing grate 141B of the first concave threshing section 140A or the fourth concave threshing grate 141D of the second concave threshing section 140B. The starting bar 44A denotes a starting end of the series, and the terminal bar 44Z denotes a terminal end of the series. Referring to the spacing between any two adjacent bars, on the same concave threshing grate as one another, as an inter-bar spacing, the width of this inter-bar spacing, for the most part, progressively increases along the series in a direction advancing from the starting end of the series toward the terminal end of the series. This direction of progressive widening of the inter-bar spacing is schematically denoted by arrow 150A for concave threshing section 140A, and arrow 150B for concave threshing section 150B. With reference to these arrows, the two concave threshing sections 140A, 140B in this embodiment match one another in the directionality of progressively widening inter-bar spaces.

FIG. 4C shows non-limiting numeric examples of the progressively increasing inter-bar spacing possessed, for the most part, by the first series of axial bars 44 on the first concave section 140A, among which there are only a very small quantity of exceptions to this progressively spaced layout of the axial bars 44, particularly at the inter-bar spaces nearest the ends 46A, 46B of the two concave threshing grates 141A, 141B of this concave threshing section 140A. One such exception is the relative sizing between the inter-bar spacing of the first and second bars 44A, 44B of the first concave threshing grate 141A and the inter-bar spacing of the second and third bars 44B, 44C on that same grate, where the latter of these two spaces is actually narrower than the former, thus deviating from the progressively widening spacing layout possessed by the majority of the series. From the third bar 44C up to the last bar 44M of the first concave threshing grate 141A, the progressive widening scheme of the inter-bar spacing is conformed to in the illustrated example.

In this embodiment, where the concave threshing section 140A is spit into two separate concave threshing grates 141A, 141B, another deviation from the spacing scheme occurs in the relative sizing between the inter-bar spacing of the last two bars 44L, 44M of the first concave threshing grate 141A and the inter-bar spacing of first and second bars 44N, 44O of the second concave threshing grate 141B, where the latter of these two spaces is actually narrower than the former, thus deviating from the progressively widening spacing layout possessed by the majority of the series. Another exemption in the present embodiment is the relative sizing between the inter-bar spacing of the first and second bars 44N, 44O of the second concave threshing grate 141B and the inter-bar spacing of the second and third bars 44O, 44P on that same grate, where the latter of these two spaces is actually narrower than the former, thus deviating from the progressively widening spacing layout possessed by the majority of the series.

From the third bar 44P up to the last bar 44Z of the second concave threshing grate 141B, the progressive widening scheme of the inter-bar spacing is conformed to in the illustrated example. Noting that these deviations from the otherwise progressively widening character of the inter-bar spaces in advancing direction along the series of bars reside near ends of the concave threshing grates, one reason for such exception is to provide a localized enlargement of inter-bar spaces near some or all end-adjacent bars of the concave threshing gates to better accommodate optional connection of concave cover plates that may rely on hooked engagement around one or more such end-adjacent bars. Nonetheless a notable majority of the inter-bar spaces follow the prescribed pattern of progressive widening, as demonstrated by the FIG. 4C example where only the inter-bar spacing between bars 44B & 44C, 44N & 44O and 44O and 44P break this general spacing scheme by being narrower by the respective preceding inter-bar space, denoting a mere three inter-bar spaces out of a total of twenty-eight three bars spaces that are an exception, denoting roughly 11% of the inter-bar spaces that break from the otherwise progressively widening bar spacing scheme. Preferably at least 70%, more preferably at least 80%, and even more preferably at least 85%, of the inter-bar spaces in any given series of progressively widening inter-bar spacing convention follow this progressively widening spacing convention, and one or more series thereamong may have at least 90% conformation to this progressively widening spacing convention.

Comparing FIG. 4D to FIG. 4C, the second series of axial bars belonging to the second concave threshing section 140B has a lesser quantity of axial bars 44 than the first series of axial bars belonging to the first concave threshing section 140A. Ignoring the relative sizing of the last-inter bar space of the first concave section between terminal bar 44Z of the first series and the sequentially preceding penultimate bar 44Y of the first series and the spacing between the first and second bars 44A, 44B of the second series as an exception to the progressively widening bar spacing scheme, the inter-bar spacing of the second series of axial bars in the second concave threshing section 140B is greater than the inter-bar spacing of the first series of axial bars in the first concave threshing section 140A, and the second series continues the progressively widening bar spacing scheme from the first series. With reference to the non-limiting numerical spacing examples given in FIGS. 4C and 4D, it can be seen how the inter-bar spacing between the first and second bars 44A, 44B of the third concave threshing grate 141C of the second concave threshing section 140B is greater than the penultimate inter-bar spacing between the penultimate and third-last bars 44Y, 44X of the second concave threshing grate 141B of the first concave threshing section 140A (again, ignoring the final inter-bar spacing between bars 44Y, 44Z as end exception case to the progressively widening spacing scheme, for example to accommodate cover-plate mounting). In the FIG. 4D example, there are zero exceptions to the progressively widening bar spacing scheme within the second series itself, which may be attributable to lack of need for localized enlargement of inter-bar spaces at the ends of the grates to accommodate cover plate mounting, given that the lesser quantity of axial bars in the second series inherently denotes wider inter-bar spacing, that in this example is wide enough at even the narrowest inter-bar spaces of this series to accommodate such mounting of cover plates, without necessitating deviation from the progressively widening bar spacing scheme.

In this first embodiment, noting the rotor spin direction 20A of the rotor at which the concave threshing sections 140A, 140B of concave threshing assembly 100 are installed, it can be seen that the directionality 150A, 150B of the progressive widening of the inter-bar spacing matches the rotor spin direction 20A in which the rotor traverses past the concave threshing sections 140A, 140B in the lower half of the rotor's circular rotation. This denotes an installation in a single-rotor combine harvester in which the sieves are known to be overloaded on a downward rotating side of the rotor at which the rotor starts its traversal across the concave threshing section 140A, 140B. So referring to the illustrated context of FIGS. 4C and 4D, the sieves, in the presence of a conventional set of factory concave grates for that machine, would be relatively overloaded at the right side of the rotor.

In the illustrated use of the concave threshing sections 140A, 140B of the inventive concave threshing assembly 100 however, the relative narrow or tight spacing of the axial bars 44 near the upper outside end 46A of the first and third concave threshing grates 141A, 141C at the right side of the figure reduces the amount of grain that is passed downwardly through the progressively spaced concave threshing grates 141A, 141C at this side of the machine where the sieves are conventionally overloaded. Meanwhile, the relative wide or open spacing of the axial bars near the opposing upper outside end 46A of the second and fourth concave threshing grates 141B, 141D at the left side of the figure increases the amount of grain that can pass downwardly through the progressively spaced concave threshing grates 141B, 141D at this side of the machine where the sieves are conventionally less loaded. The result is more balance or uniform loading of the sieves across the width of the machine. In the meantime, the narrower or tighter space between the bars of the first concave threshing section 140A compared to the wider or more open space between the bars of the second concave threshing section 140B provides a greater threshing action at the first section 140A than at the second section 140B, and then unloads the threshed grain faster at the second concave threshing section 140B, in advance of the subsequent separation section(s) (which may be of conventional design, and are thus not illustrated in the present embodiment).

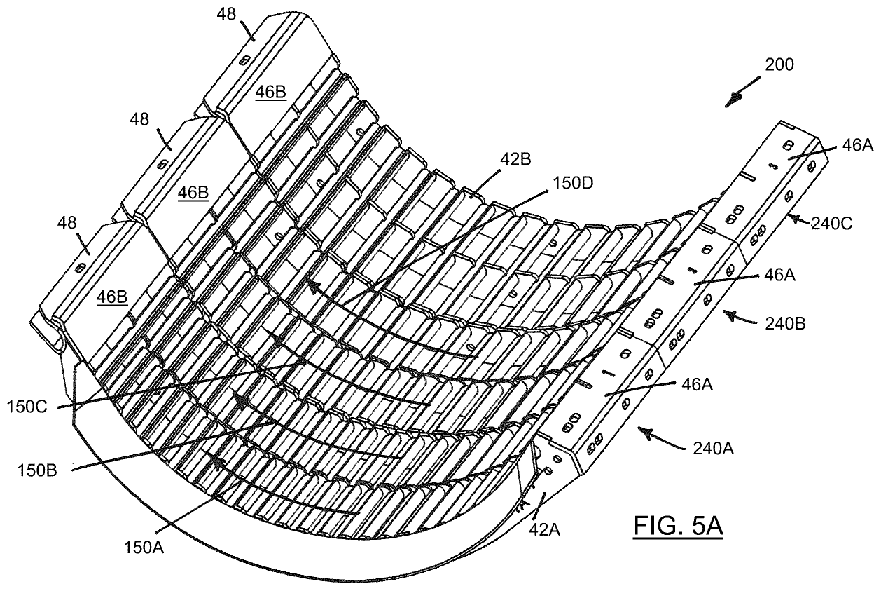

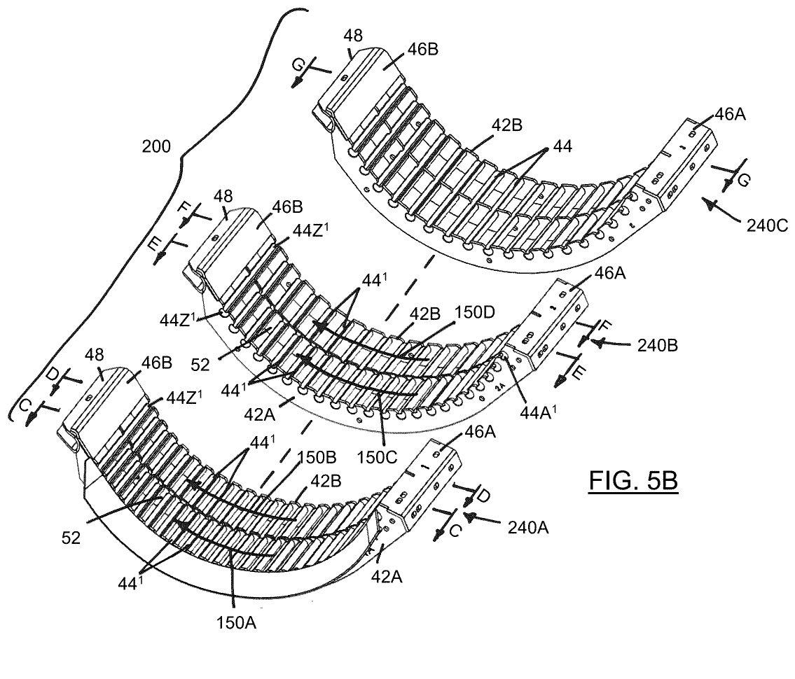

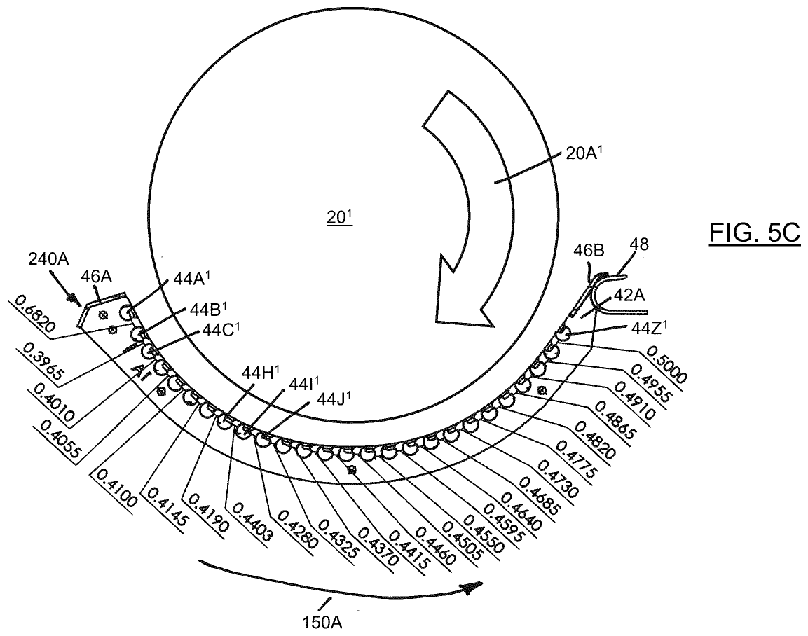

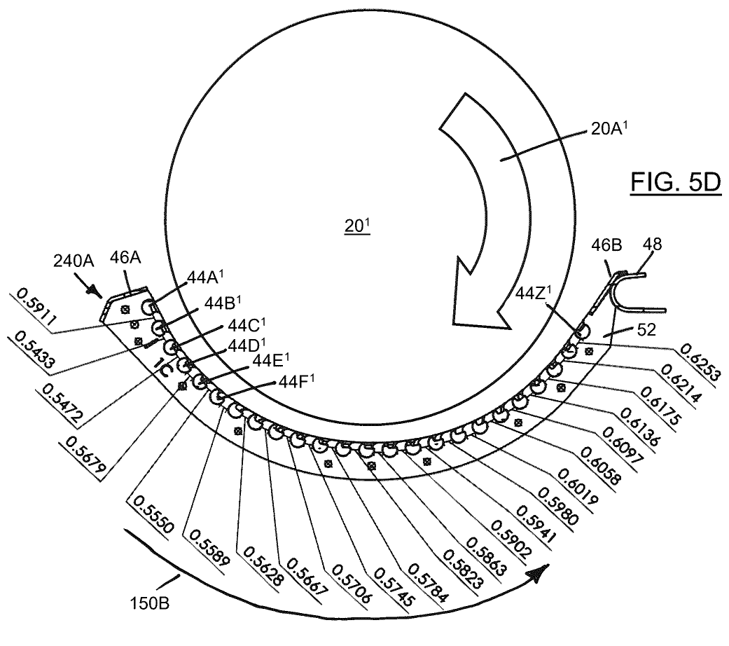

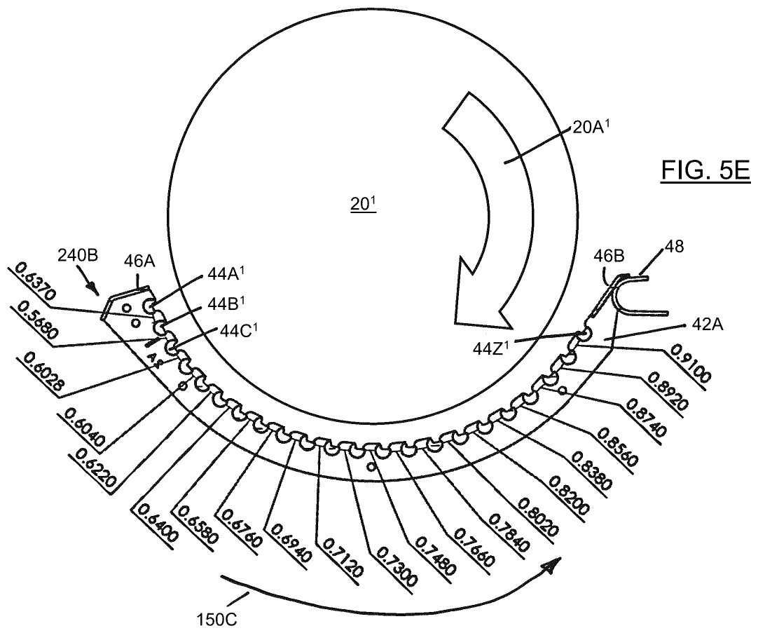

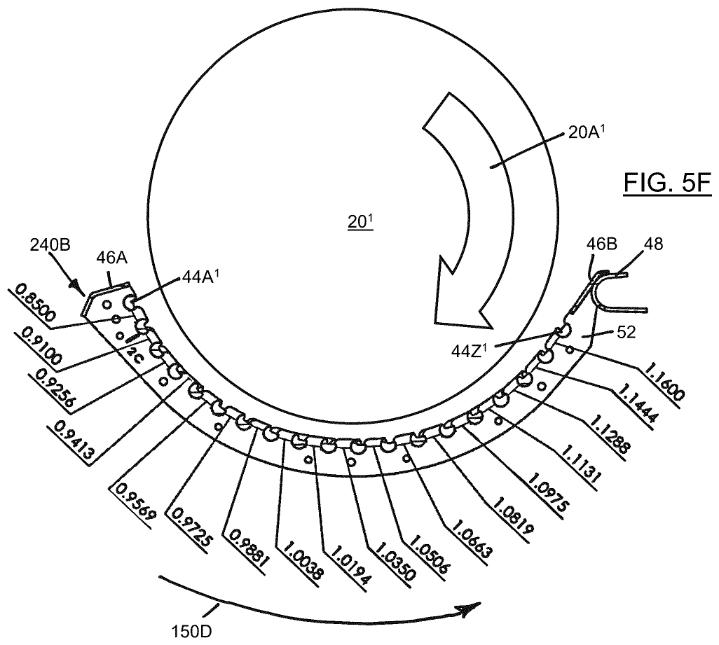

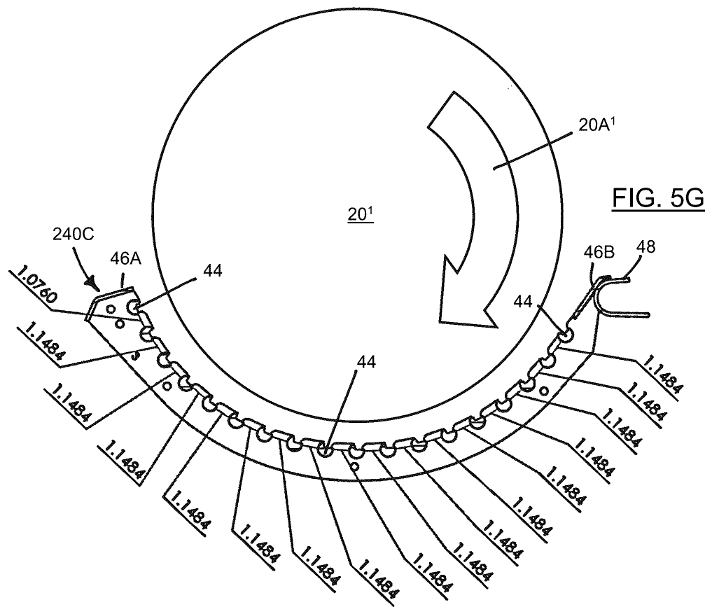

FIGS. 5A through 5G illustrates a concave assembly 200 of a second embodiment of the invention, which is shown to have a frontmost first concave threshing section 240A, a second concave threshing section 240B of rearwardly neighbouring relationship thereto in the same manner described of the first and second threshing sections 140A, 140B of the preceding embodiment, and a third concave separating section 240C of rearwardly neighbouring relationship to the second concave threshing section 240B. This embodiment features a singular grate per section, like the prior art of FIG. 3A, and so the term section and grate may be used interchangeably in this embodiment. One way in which this second embodiment differs from the preceding embodiment is that each concave threshing grate 240A, 240B, instead of hosting a singular series of full-length axial bars 44, hosts two series of partial-length axial bars 44′. In the illustrated example, the axial bars 44′ of the two series are of equal length, each spanning a respective half of the overall axial measure of the concave threshing grate from the front side rail 42A to the rear side rail 42. The axial bars 44′ in this example may therefore be referred to herein as half-length bars, or simply half bars 44′ for brevity. Instead of a singular mid rail 52, this embodiment feature two mid rails 52 residing side by side in abutted relation to one another, with each of the two mid rails hosting a respective set of slots for axially inner ends of the half bars 44′ of a respective one of the two series of this grate.

The bars of each series are again characterized, for at least the most part, by inter-bar spacing of progressively widening character moving from a starting end of the series, denoted by starting half bar 44A′ nearest to one end 46A of the concave threshing grate 240A, 240B, to a terminal end of the series, denoted by terminal half bar 44Z′ nearest to the other end 48 of the concave threshing grate 240A, 240B. Referring to the first series of half bars 44′ on the front half of the first concave threshing grate 240A in FIG. 5C, the same first exception to the progressively inter-bar spacing scheme may apply as did to the first embodiment, wherein the relative sizing of the inter-bar spacing of the first and second bars 44A′, 44B′ of the first series on the first concave threshing grate 240A and the inter-bar spacing of the second and third bars 44B′, 44C′ in that same series deviates from the scheme, in that the latter of these two spaces is actually narrower than the former. Other than this, and one other exception where the spacing between the eighth and ninth half bars 44H′, 44l′ is wider than the spacing between the ninth and tenth half bars 44l′, 44J′, the progressive widening scheme of the inter-bar spaces, in the illustrated example, is conformed to from the third half bar 44C′ up to the last half bar 44Z′ of the first series of half bars on the first concave threshing grate 240B.

With reference to FIG. 5D, the second series of half bars 44′ found on the rear half of the first concave threshing grate 240A has a lesser quantity of half bars 44′ than the first series of half bars 44′. The inter-bar spacing of the second series of half bars on the same first concave threshing section 240A as the first series of half bars is greater than the inter-bar spacing of the first series of half bars, and continues the progressively widening bar spacing scheme from the first series. As shown in the non-limiting numerical examples of the illustrating spacing, the same first exception to the progressively widening inter-bar spacing scheme of the second series may apply as did to the first series, wherein the relative sizing of the inter-bar spacing of the first and second bars 44A′, 44B′ of the second series on the first concave threshing grate 240A and the inter-bar spacing of the second and third bars 44B′, 44C′ in that same series deviates from the scheme, in that the latter of these two spaces is actually narrower than the first. Other than this, and one other exception where the spacing between the fourth and fifth half bars 44D′, 44E′ is wider than the spacing between the fifth and sixth half bars 44E′, 44F′, the progressive widening scheme of the inter-bar spaces, in the illustrated example, is conformed to from the third half bar 44C′ up to the last half bar 44Z′ of the second series of half bars on the first concave threshing grate 240A. As with the preceding embodiment, the directionality of the progressively widening inter-bar spacing is denoted for the first and second series of half bars by arrows 150A and 150B, which are again seen to match one another.

With reference to FIG. 5E, the third series of half bars 44′, found on the front half of the second concave threshing grate 240B, has a lesser quantity of half bars 44′ than the second series of half bars 44′ belonging to the rear half of the first concave threshing grate 240A. The inter-bar spacing of the third series of axial bars on the second concave threshing section 240B, for the most part, in this case ignoring the last inter-bar spacing of the second series and the first four inter-bar spaces of the third series, is greater than the inter-bar spacing of the second series of axial bars on the first concave threshing grate 240A, and continues the progressively widening bar spacing scheme from the second series. As shown in the non-limiting numerical examples of the illustrating spacing, the same first exception to the progressively inter-bar spacing scheme of the third series may apply as did to the first and second series, wherein the relative sizing of the inter-bar spacing between the first and second bars 44A′, 44B′ of the third series on the second concave threshing grate 240B and the inter-bar spacing between the second and third bars 44B′, 44C′ in that same series deviates from the scheme, in that the latter of these two spaces is actually narrower than the former. Other than this, the progressive widening scheme of the inter-bar spaces, in the illustrated example, is conformed to from the third half bar 44C′ up to the last half bar 44Z′ of the third series of half bars on the second concave threshing grate 240B. The directionality of the progressively increasing of the inter-bar spacing width of the third series of half bars 44′ is denoted by arrow 150C, which is seen to again seen to match those 150A, 150B of the first and second series.

With reference to FIG. 5F, the fourth series of half bars 44′, found on the rear half of the second concave threshing grate 240B, has a lesser quantity of half bars 44′ than the third series of half bars 44′. The inter-bar spacing of the fourth series of axial bars on the second concave threshing section 240B, for the most part, in this case ignoring only the final inter-bar spacing of the third series and first inter-bar spacing of the fourth series, is greater than the inter-bar spacing of the third series of axial bars and continues the progressively widening bar spacing scheme from the third series. Other than this isolated discontinuity from the progressively widening scheme of the preceding series, the progressive widening scheme of the inter-bar spaces, in the illustrated example of this fourth series, is conformed to throughout this fourth series on the rear half of the second concave threshing grate 240B. The directionality of the progressively increasing width of the inter-bar spacing of the fourth series of half bars 44′ is denoted by arrow 150D, which is seen to again seen to match those 150A-150C of the first, second and third series.

The concave separating grate 240C has full-length axial bars 44 like the concave threshing grates 141A-141D of first embodiment, thus having only a singular series of bars, which, as illustrated in FIG. 5B, may have a substantially uniform bar spacing scheme, with only one exemption at the first inter-bar space of the series in the illustrated example, unlike the progressively spaced concave threshing grates 240A, 240B that precede it. This implementation denotes an example where there is no unbalanced overloading problem across the width of the machine at this separating section. The uniform inter-bar spacing at this concave separating grate 240C, ignoring the exceptional first inter-bar space, may be greater than at least a majority of the inter-bar spacing of the fourth series of half bars on the second concave threshing grate 240B, and in the illustrated example is greater than all but the very last inter-bar spacing width of the fourth series of half bars.

In this second embodiment, noting the rotor spin direction 20A of the rotor at which the concave threshing sections 240A, 240B of the concave assembly 200 are installed, it can be seen that the directionality 150A-150D of the progressive widening of the inter-bar spaces among the four different series of half bars 44′ oppose the rotor spin direction 20A in which the rotor traverses past the concave grates 240A-240C in the lower half of the rotor's circular rotation. This denotes an installation in a single-rotor combine harvester in which the sieves beneath the concave threshing sections are known to be overloaded on an upward rotating side of the rotor at which the rotor finishes its traversal across the concave threshing section 140A, 140B. In the illustrated context of FIGS. 5C through 5F, the sieves, in the presence of a conventional set of factory concave grates for that machine, would be relatively overloaded at the left side of the rotor, in opposition to the scenario illustrated in first embodiment. Applicant has also noted a tendency of the conventional factory concave grates for this machine to wear more quickly near the on this same side of the rotor.

In the illustrated use of the progressively spaced concave threshing sections 240A, 240B of the inventive concave assembly 200, the relatively narrow or tight spacing of the axial bars near the illustrate left ends 46A of the first and second concave threshing grates 240A, 240B reduces the amount of grain that is passed downwardly through the progressively spaced concave threshing grates 141A, 141C at this side of the machine where the sieves are conventionally overloaded, and also slows down the wearing of the grate. Meanwhile, the relatively wide or open spacing of the axial bars near the opposing right ends 48 of the concave threshing grates 240A, 240B increases the amount of grain that can pass downwardly through the progressively spaced concave threshing grates 240A, 240B at this side of the machine where the sieves are conventionally less loaded. The result is more balanced or uniform loading of the sieves across the width of the machine. In the meantime, the progressive widening of the inter-bar spaces in a rearward axial direction through the machine from each series of half bars 44 to the next provides a greater threshing action at the first series at the front half of the first concave threshing grate 240B, with this threshing aggression gradually reducing at the second series onward, where increasing openness of the grates unloads the threshed grain faster at as in sequential rearward advancement from series to series.

It will be appreciated that the same use of half-bars to accommodate two series of differently spaced bars in a singular concave threshing section may similarly be adopted in the dual-grate threshing sections of the first embodiment, and likewise, that full-length bars laid out in a singular series per concave threshing grate may be employed in the operating context of the second embodiment, where the directionality of the progressively widening bar spacing scheme is opposite to the rotor spin direction. In any embodiment where the notched axial bars 44, 44′ are used, the notched side thereof should face oppositely of the rotor spin direction, as illustrated for both of the first and second embodiments.

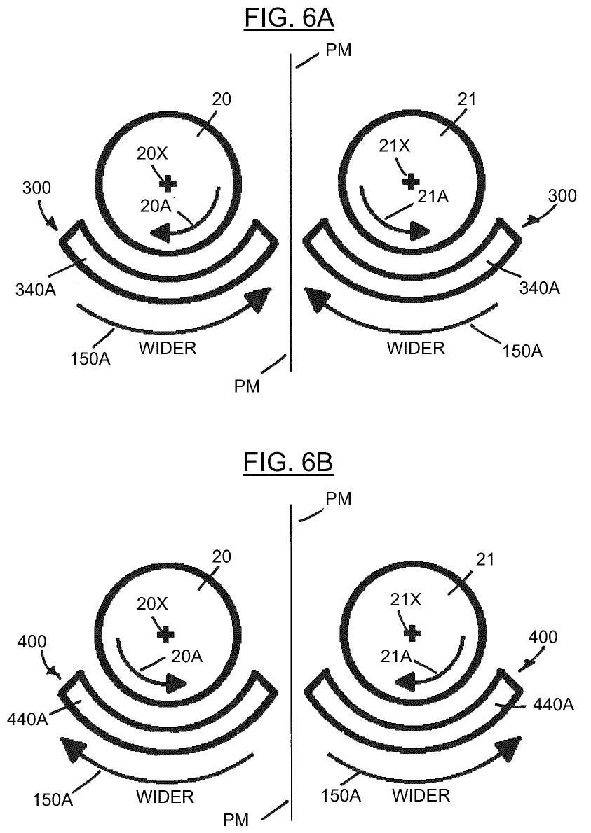

Finally, turning to FIGS. 6A and 6B, illustrated schematically therein is the application of the same inventive principles to a twin-rotor combine harvester with two parallel rotors. FIG. 6A is a schematic representation of a twin-rotor combine harvester whose two rotors 20, 21 are driven in counter-rotating directions 20A, 21A in which they both spin outwardly away from a center of the combine harvester in the bottom half of their rotations. Each rotor 20, 21 is rotationally driven about its respective longitudinal rotor axis 20X, 21X, which two rotor axes lie parallel to one another, and longitudinally of the combine harvester, in symmetric relationship to one another across a vertical midplane P_{M} that is situated in-between the two rotors 20, 21 and midway between the respective rotor axes 20X, 21X thereof. Each rotor 20, 21 is accompanied by a respective concave threshing grate assembly 300, the front concave threshing grate 340A of which is shown in the schematic illustration, and which resides beneath the respective rotor 20, 21 in a position of roughly circumferential and concentric relation thereto, as is known in the art and likewise described and illustrated of the preceding single rotor embodiments. The vertical midplane P_{M} is a schematic representation of the lateral center of the twin-rotor combine harvester. In use of conventional concave threshing grates in at least some twin-rotor combine harvesters of this type, overloading of the sieves typically occurs at laterally outward regions thereof of laterally distant relation to the midplane P_{M}, perhaps owing at least in part, to the bottom-outward rotor spin directionality 20A, 21A.

To solve or mitigate this problem in the FIG. 6A scenario, the concave threshing grates 340A are positioned and oriented such that the directionality 150A of the progressively widening inter-bar spacing scheme of each series of progressively spaced bars on each concave threshing grate is opposite to the rotor spin direction 20A, 21A, whereby the relatively narrow or tight inter-bar spacing early in the series near the starting end thereof resides distally outward from the midplane P_{M}, and the relative wide or open inter-bar spacing late in the series near the terminal end thereof resides closely proximate to the midplane, cooperate to promote a more uniform unloading of the threshed grain across the full arcuate span of each concave threshing grate compared to use of the conventional concave threshing grates that tend to unload more at the outside end thereof furthest from the midplane than at the inside end thereof nearest the midplane. Meanwhile, the series of bars in each of the two concave threshing grate assemblies 300 have progressively wider inter-bar spacing moving rearward through the assembly 300 in the axial direction of the rotors 20, 21, just as described in the preceding single rotor embodiments, to promote greater threshing at the first frontmost series, with faster unloading at each subsequently more rearward series. The concave threshing grates of the concave threshing grate assemblies 300 may be like those of the first embodiment, with one series of axial bars per grate, or like those of the second embodiment, with more than one series of axial bars (e.g. two series of half bars) per grate.

FIG. 6B is a schematic representation of a twin-rotor combine harvester whose two rotors 20, 21 are instead driven in counter-rotating directions 20A, 21A in which they both spin inwardly toward the center of the combine harvester in the bottom half of their rotations. Each rotor 20, 21 is again rotationally driven about its respective longitudinal rotor axis 20X, 21X, which two rotor axes lie parallel to one another, and longitudinally of the combine harvester, in symmetric relationship to one another across the vertical midplane P_{M} that is situated in-between the two rotors 20, 21 and midway between the respective rotor axes 20X, 21X thereof. Each rotor 20, 21 is again accompanied by a respective concave threshing grate assembly 400, the front concave threshing grate 440A of which is shown in the schematic illustration, and which resides beneath the respective rotor 20, 21 in a position of roughly circumferential and concentric relation thereto, as is known in the art and likewise described and illustrated of the preceding embodiments. The vertical midplane P_{M} is again a schematic representation of the lateral center of the twin-rotor combine harvester. In use of conventional concave threshing grates in at least some twin-rotor combine harvesters of this type, overloading of the sieves typically occurs at or near the midplane P_{M}, perhaps owing, at least in part, to the bottom-inward rotor spin directionality 20A, 21A.

To solve or mitigate this problem in the FIG. 6B scenario, the concave threshing grates 440A are again positioned and oriented such that the directionality 150A of the progressively widening inter-bar spacing scheme of each series of progressively spaced bars on each concave threshing grate is opposite to the rotor spin direction 20A, 21A, whereby the relatively narrow or tight inter-bar spacing early in the series near the starting end thereof resides closely proximate to the midplane P_{M}, and the relative wide or open inter-bar spacing late in the series near the terminal end thereof resides distally outward from the midplane, cooperate to promote a more uniform unloading of the threshed grain across the full arcuate span of each concave threshing grate compared to use of the conventional concave threshing grates that tend to unload more at the inside end thereof nearest the midplane than at the outside end thereof furthest from the midplane. Meanwhile, the series of bars in each of the two concave threshing grate assemblies 400 again have progressively wider inter-bar spacing moving rearward through the assembly 400 in the axial direction of the rotors 20, 21, just as described in the preceding embodiments, to promote greater threshing at the first frontmost series, with faster unloading at each subsequently more rearward series. The concave threshing grates of the concave threshing grate assemblies 400 may again be like those of the first embodiment, with one series of axial bars per grate, or like those of the second embodiment, with more than one series of axial bars (e.g. two series of half bars) per grate.

Since various modifications can be made in the invention as herein above described, and many apparently widely different embodiments of same made, it is intended that all matter contained in the accompanying specification shall be interpreted as illustrative only and not in a limiting sense.

1. A concave assembly for an axial flow combine harvester having at least one rotor, whose rotation axis lies longitudinally of the combine harvester and defines an axial direction, relative to which the concave assembly is designed for installation thereof in a position and orientation underlying said rotor and arching transversely of the rotation axis in radially spaced relation from the rotor to span partially therearound in a circumferential direction, wherein the concave assembly comprises:
one or more concave sections comprising one or more concave grates having arc-shaped rails spanning in said circumferential direction and axial bars supported on said arc-shaped rails and lying parallel to one another in the axial direction;
said axial bars comprising at least:
a first series of axial bars distributed in spaced apart relation to one another in the circumferential direction spanned by the arc-shaped rails; and
a second series of axial bars also distributed in spaced apart relation to one another in the circumferential direction spanned by the arc-shaped rails;
among which the first and second series occupy longitudinally distinct first and regions of the concave assembly, of which the first region resides nearer to a front intake end of the concave assembly, at which crop material is first introduced to the concave assembly during use of the combine harvester, than to a longitudinally opposing terminal rear end of the concave assembly, toward which the crop material is axially advanced by helical movement around the rotor in use of the combine harvester;
wherein spacing between adjacent pairs of the axial bars in each series, of which a respective two bars of each pair reside on a same one of the grates within a same one of the series, is characterized, at least for the most part, by a progressively widening character that grows progressively wider from a relatively narrow spacing at or near a first end of the series to a relatively wider spacing at or near an opposing second end of the series, and the spacing between said adjacent pairs of the axial bars, in the second series, is further characterized, at least for the most part, by a progressive widening thereof relative to the spacing between the adjacent pairs of the axial bars in the first series.

2. The concave assembly of claim 1 wherein the one or more concave sections comprise separate first and second sections each possessing separate respective first and second sets of said arc-shaped rails that are of unconnected relationship to one another, and among which the first and second series of axial bars are respectively and separately possessed by the first and second sections.

3. The concave assembly of claim 1 one of the one or more sections comprises first and second concave grates arranged to reside adjacently end-to-end to one another to span respective shares of an overall arcuate span of said one of the one or more sections.

4. The concave assembly of claim 3 wherein a relative sizing of the spacing between a last pair of adjacent bars on the first concave grate and the spacing between a next pair of adjacent bars on the second concave grate, which reside in sequentially adjacent relationship to said last pair of adjacent bars in the series to which said last and first pairs of adjacent bars belong, is non-contributory to the progressively widening character otherwise possessed, for the most part, by said series to which said last and next pairs of bars belong.

5. The concave assembly of claim 4 wherein a relative sizing of the spacing between said next pair of adjacent bars on the second concave grate and the spacing between a subsequent pair of adjacent bars on the second concave grate, which reside in sequentially adjacent relationship to said next pair of adjacent bars in the series to which said next and subsequent pairs of adjacent bars belong, is also non-contributory to the progressively widening character otherwise possessed, for the most part, by said series to which said next and subsequent pairs of bars belong.

6. The concave assembly of claim 3 wherein the first series of axial bars are embodied on the first and second concave grates, and the second series of axial bars are embodied in another of the one or more sections.

7. The concave assembly of claim 6 wherein said another of the one or more sections comprises third and fourth concave grates arranged to reside adjacently end-to-end to one another to span respective shares of an overall arcuate span of said another of the one or more sections.

8. The concave assembly of claim 7 wherein the third concave grate resides axially adjacent to the first concave section, and the fourth concave grate resides axially adjacent to the second concave section.

9. The concave assembly of claim 8 wherein the relatively narrow spacing at or near the second end of the first series is embodied in the second concave grate, and the relatively wide space at or near the first end of the second series is embodied in the third concave grate.

10. The concave assembly of claim 1 wherein the first and second series of axial bars are at least partially embodied on a shared one of the concave grates.

11. The concave assembly of claim 10 wherein the first and second series of axial bars are fully embodied on said shared one of the concave grates.

12. The concave assembly of claim 10 wherein said shared one of the concave grates is accompanied by another concave grate on which a third series of axial bars are at least partially embodied.

13. The concave assembly of claim 12 wherein said third series of axial bars are fully embodied on said another concave grate.

14. The concave assembly of claim 12 wherein said third series of axial bars also possess, at least for the most part, said progressively widening character.

15. The concave assembly of claim 14 wherein the spacing between said adjacent pairs of the axial bars, in the third series, is further characterized, at least for the most part, by a progressive widening thereof relative to the spacing between the adjacent pairs of the axial bars in the second series.

16. The concave assembly of claim 14 wherein the progressive widening of the spacing, in at least the second and third series, occurs in a same matching direction.

17. The concave assembly of claim 12 wherein a fourth series of axial bars are at least partially embodied on said another concave grate.

18. The concave assembly of claim 17 wherein said fourth series of axial bars are fully embodied on said another concave grate.

19. The concave assembly of claim 17 wherein said fourth series of axial bars also possess, at least for the most part, said progressively widening character.

20. The concave assembly of claim 18 wherein the spacing between said adjacent pairs of the axial bars, in the fourth series, is further characterized, at least for the most part, by a progressive widening thereof relative to the spacing between the adjacent pairs of the axial bars in the third series.

21. The concave assembly of claim 19 wherein the progressive widening of the spacing, in at least the third and fourth series, occurs in a same matching direction.

22. The concave assembly of claim 17 comprising yet another concave grate on which a fifth series of axial bars is at least partially embodied.

23. The concave assembly of claim 22 wherein said fifth set of axial bars are fully embodied on said yet another concave grate.

24. The concave assembly of claim 22 wherein the spacing between the adjacent pairs of the axial bars, in said fifth set, bars lacks, at least for the most part, the progressively widening character.

25. The concave assembly of claim 24 wherein the spacing between the adjacent pairs of the axial bars, in said fifth set, is, at least for the most part, uniform.

26. The concave assembly of claim 1 wherein the progressive widening of the spacing, in the first and second series, occurs in a same matching direction.

27. An axial flow combine harvester having installed therein the concave assembly of claim 1.

28. The axial flow combine harvester of claim 27 wherein a rotor spin direction of the rotor, at a bottom half of each rotation thereof, is of matching directional relationship to the progressively widening character of the spacing between the adjacent bars in at least one of the series.

29. The axial flow combine harvester of claim 28 wherein the rotor spin direction is of said matching directional relationship to the progressively widening character of the spacing between the adjacent bars in each and every series of the axial bars.

30. The axial flow combine harvester of claim 27 wherein a rotor spin direction of the rotor, at a bottom half of each rotation thereof, is of opposite directional relationship to the progressively widening character of the spacing between the adjacent bars in at least one of the series.

31. The axial flow combine harvester of claim 30 wherein the rotor spin direction is of said opposing directional relationship to the progressively widening character of the spacing between the adjacent bars in each and every series of the axial bars.

32. A twin-rotor axial flow combine harvester having installed therein two concave assemblies according to claim 1, of which each concave assembly is installed in operative relationship to a respective one of two rotors of said twin-rotor axial flow combine harvester.

33. The twin-rotor axial flow combine harvester of claim 32 wherein the two concave assemblies are installed in orientations in which the progressively widening character of the spacing the adjacent bars, in at least one of the series, grows progressively wider inwardly toward a vertical midplane that lies axially of, and in-between, the two rotors.

34. The twin-rotor axial flow combine harvester of claim 33 wherein the progressively widening character of the spacing the adjacent bars, in each and every series, grows progressively wider toward the vertical midplane.

35. The twin-rotor axial flow combine harvester of claim 33 wherein at least one of the two rotors are driven in a direction that, in a bottom half the rotor's driven rotation, spins the rotor outwardly away from the midplane.

36. The twin-rotor axial flow combine harvester of claim 33 wherein the two rotors are driven in counter-rotating directions that, in a bottom half each rotor's driven rotation, spins the rotor outwardly away from the midplane.

37. The twin-rotor axial flow combine harvester of claim 32 wherein the two concave assemblies are installed in orientations in which the progressively widening character of the spacing the adjacent bars, in at least one of the series, grows progressively wider outwardly away from a vertical midplane that lies axially of, and in-between, the two rotors.

38. The twin-rotor axial flow combine harvester of claim 37 wherein the progressively widening character of the spacing the adjacent bars, in each and every series, grows progressively wider outwardly away from the vertical midplane.

39. The twin-rotor axial flow combine harvester of claim 37 wherein at least one of the two rotors are driven in a direction that, in a bottom half the rotor's driven rotation, spins the rotor inwardly toward the midplane.

40. The twin-rotor axial flow combine harvester of claim 37 wherein the two rotors are driven in counter-rotating directions that, in a bottom half each rotor's driven rotation, spins the rotor inwardly toward the midplane.

41. A method of improving operational characteristics of an axial flow combine harvester in which unloading of one or more concave grates of a conventional design for said combine harvester to cooperating sieves of the combine harvester is known to involve uneven loading of said sieves from said one or more concave grates, said method comprising obtaining at last one set of one or more concave grates possessing at least one series of axial bars that, for at least the most part, are laid out with progressively wider spaces between adjacent pairs of said bars starting from a relatively narrow spacing at or near a first end of the series to a relatively wider spacing at or near an opposing second end of the series, and installing said one or more concave grates in operational relationship to a rotor of said axial flow combine harvester in an installed position and orientation where the relatively narrow spacing resides at a side of the rotor where sieve overloading is known to occur with said one or more concave grates of a conventional design, and said relatively wider spacing resides at an opposing side of the rotor from said sieve overloading is known to occur.

42. The method of claim 41 wherein said installed position and orientation is one in which in which said progressively wider spaces are progressively wider in a direction of opposing relation to a direction in which said rotor spins in a bottom half of its rotation.

43. The method of claim 41 wherein said installed position and orientation is one in which in which said progressively wider spaces are progressively wider in a direction of matching relation to a direction in which said rotor spins in a bottom half of its rotation.

44. The method of claim 41 wherein said axial flow combine harvester is a twin-rotor axial combine harvester, and said at least one set of one or more concave grates comprises two sets thereof, of which each set is installed in said operational relationship to a respective one of said two rotors.
